(19) United States
(12) Patent Application Publication
(10) Pub. No.: US 2015/0120612 A1
(43) Pub. Date: Apr. 30, 2015

(54) BINIOG SATHI APPARATUS, SYSTEM, AND A METHOD THEREOF

(71) Applicant: Mabroor Mahmood, Dhaka (BD)

(72) Inventor: Mabroor Mahmood, Dhaka (BD)

(21) Appl. No.: 14/569,782

(22) Filed: Dec. 14, 2014

Related U.S. Application Data
(63) Continuation-in-part of application No. 13/621,682, filed on Sep. 17, 2012, now abandoned.

(51) Int. Cl. G06Q 40/06

(52) U.S. Cl. CPC G06Q 40/06; G06Q 40/025
USPC 705/36 R

(57) ABSTRACT

The present invention relates generally to an inventive concept in investment and charitable contributions. The present invention also contemplates modifying the existing banking model with the incorporation of a zakat or charity fund that will allow the financial institutions to mitigate the default risk for loans. This invention finds a sustainable solution to the problems of debt default in the financial services industry with the help of zakat or charity funds from a partnering zakat or charity entity. It also strengthens the existing Islamic banking model complying with all the sharia principles. This invention develops a banking model that will be acceptable to all individuals and businesses seeking loans irrespective of race, color, religion, social class, etc., and wherein each loan being given by the financial services industry to a borrower using the Biniog Sathi process is backed or supported by a charity entity using zakat or charity funds.

### CROSS-REFERENCE TO RELATED APPLICATION

The instant patent application is a Continuation-in-Part of pending U.S. patent application Ser. No. 13/621,682, filed on Sep. 17, 2012, titled “BINIOG SATHI APPARATUS, SYSTEM, AND A METHOD THEREOF”, the entire disclosure of the pending patent application is incorporated herein by reference.

### FIELD OF THE INVENTION

The present invention relates generally to an inventive concept in investment and charitable contributions. More particularly, the invention encompasses a Biniog Sathi apparatus, system, and a method thereof. The present invention also contemplates modifying the existing banking model with the incorporation of a zakat or charity fund from a zakat or charity entity that will allow the financial institutions to mitigate the default risk for loans.

### BACKGROUND INFORMATION

In the financial services industry a major problem is debt default, and this problem persists in the financial services industry throughout the world. Any bank, no matter whether it is a conventional bank, an Islamic bank, or a micro-finance institution, they are all exposed to the possibility of debt default by its borrowers.

At present, there are at least three types of banking models that are being operated all over the world. The first and most popular one is the conventional banking system, which is based on interest based principles. The second is the Islamic banking model, which is guided by the Islamic Sharia principles. The third is the microfinance system, which is based on collective group approach.

In microfinance institutions loans are extended to poor people, microentrepreneurs, and small businesses, without any collateral. On the other hand, in the Islamic financial institutions, the financing modes are free of interest or Riba, and usually involve the ownership of assets by the bank, complying the Islamic Sharia principles.

All these banking models have common problems of loan default, which basically means that if the borrower is unable to repay the loans, the lender forces the borrower to pay-off the loans either through selling of the assets or through filing claims on the securities in the court, or similar other loan collection method. Under these circumstances a borrower, if he/she is a true defaulter, faces innumerable financial losses that eventually might ruin his/her life.

Although the above mentioned banking models are different in their operational mechanisms, the basic structure of the banking model is similar in terms of their treatment to the borrowers in case of default. In all the banking models mentioned above, there is no existing mechanism for assisting the borrowers if they default on their loans.

These debt defaults occur in the financial services industry due to a variety of reasons, such as, for example, changes in economic climate, mismanagement of assets, not enough collateral to support the debt, to name a few.

Various efforts have been done in the past to address this persistent problem in the financial sector, but they have had limited success.

U.S. Pat. No. 5,466,919 (Henry Hovakimian), the entire disclosure of which is incorporated herein by reference, discloses a method which enables a credit cardholder to make a donation to a cardholder-selected charity any time he makes a purchase using the credit card. The method comprises a credit/charge card which identifies on its magnetic strip, charities to receive a donation, and a bank expedited system which processes the card user's purchase transaction, pays a previously decided amount to the charity or charities and also bills the cardholder. In this system, the donated amounts may be paid by the bank or card issuing organization, or the cardholder may add an amount which he pays to the selected charity. The proposed system may be described as being a bank expedited charity donation, (abbreviated to BAX) approach for credit/charge cardholders.

U.S. Pat. No. 6,519,573 (Randi Shade, et al.), the entire disclosure of which is incorporated herein by reference, discloses a new method and system for enabling three-party charitable gift giving. A host operates a central server, such as a web site, and potentially other support services, such as telephonic support. A gift giver visits the host web site and selects a donation amount and a gift recipient. The host then transmits the charitable gift to the gift recipient, along with a unique code which enables the gift recipient to redeem the charitable gift. The gift recipient then visits the host web site, selects a charity from a list of available options, and the gift is sent to the selected donee charity by the host.

U.S. Pat. No. 6,542,875 (Steven Mulvihill, et al.), the entire disclosure of which is incorporated herein by reference, discloses a limited partnerships formed for specified public purposes, such as qualified low-income and elderly housing construction and services, are federally tax advantaged. In accordance with the present invention, tax credits and/or passive losses are leveraged by being directed into a method of funding charitable works, for instance school construction projects. A $SI million investment in a qualifying tax credit and/or passive loss plan, with recoupment of the investment after 13 years, will return 8.05% after taxes over 13 years if 50% of the tax credit amounts are donated to a qualified charity or public entity; this results in a net benefit to the donor of $1,759,450 and a total contribution to the charitable entity of $615,000. That contribution can, in accordance with the invention, fund the issuance and retirement of municipal bonds secured principally by the contribution, sufficient for a school construction project of about $500,000.

U.S. Pat. No. 7,593,881 (Howard E. Winklevoss, et al.), the entire disclosure of which is incorporated herein by reference, discloses methods and systems for facilitating donor-directed asset management are provided. In one embodiment, a program agreement may be established between a donor and a donee and an asset may be donated from the donor to the donee. The program agreement may specify, among other things, a period of time for investing the asset. The donor may invest the asset after donating it to the donee according to the terms of the program agreement. The investment of the asset may be monitored by an administrator to help ensure compliance with the program agreement. When the period for investing expires, the donor may relinquish investment control, and the asset and any proceeds realized by its investment may be transferred to the donee.

U.S. Pat. No. 8,156,000 (Michael P. Thompson), the entire disclosure of which is incorporated herein by reference, relates to facilitating retail transactions between participating enrolled members and participating merchants who fund rebate offers targeted to enrolled members based upon a member's past account purchase transaction information, spending habits or member profile information, on qualifying purchases. Account purchase transaction information of merchants funding rebates is monitored by one or more processors at a location(s) other than the participating merchant's location to determine whether a purchase transaction was consummated between an enrolled member and a particular participating merchant, and whether such transaction entitles the member to a merchant funded rebate or reward. The remote monitoring and determining gives the rebate program transparency; no special purpose cards/accounts, or loyalty cards need to be presented by the member and no additional checkout procedures or special equipment are needed by the participating merchants. The rebates or rewards earned can be applied to various accounts, financial instruments or obligations.

U.S. Patent Publication No. 2003/0065572 (Carolyn McNee, et al.), the entire disclosure of which is incorporated herein by reference, relates to a method of donating to charity in which a member shopper recruited by one member merchant, by making a purchase at any member merchant, makes a donation to a charity selected by the member shopper. The method comprises receiving a contribution request from the member merchant, the contribution request being responsive to a purchase made by the member shopper at the member merchant and comprising a member shopper identifier, a member merchant identifier, and a purchase amount; associating the member shopper identifier with fields in a database associated with the member shopper, the member shopper's fields including a list of at least one charity previously selected by the member shopper associating the member merchant identifier with fields in a database associated with the member merchant, the merchant's fields including contribution instructions; storing data relating to the purchase in the member shopper's fields; donating to at least one selected charity, the amount of the donation being based on the purchase amount and the merchant contribution instructions; and, for the member merchant that recruited the member shopper, generating a report that includes information about the purchases made by the member shopper.

U.S. Patent Publication No. 2004/0236654 (Joanne Marlowe-Noren), the entire disclosure of which is incorporated herein by reference, discloses a financial instrument in accordance with the principles of the present invention promotes consumer investment using a consistently formatted investment unit, which fosters the development of a secondary market for those investment units thus affording certain investment liquidity to the consumer. Specifically, the present invention creates a standardized platform for the operation of a consumer-oriented Shari'ah compliant security in support of certain depository account functions that are themselves Shari'ah compliant, but more in keeping with conventional economic or banking norms such that passive to semi-passive consumer deposits originating form the Muslim market sector may be cultivated and promoted within banks and like financial institutions. A financial instrument formulated in accordance with the principles of the present invention provides for the creation of a far more manageable and efficient consumer-based Islamic investment account function than present practices permit. Further, a networked application of the present invention can overcome significant logistical considerations to appointing and designating a SSB for on-going matters of Shari'ah compliance and supervision.

U.S. Patent Publication No. 2004/0249735 (Michael Joseph Cassani, et al.), the entire disclosure of which is incorporated herein by reference, discloses an investment fund in which a portion of the assessed investment fund fees and/or investment fund service providers' fees are designated for donation to charitable causes as directed by each of the investment fund's shareholders. Shareholders of one or more charitable share classes designate one or more charities to receive the accumulated donation amounts attributable to their individual accounts. Donation amounts are then tracked and paid to charities on a periodic basis according to the designations on the records of the investment fund.

U.S. Patent Publication No. 2005/0021353 (Karen Aviles, et al.), the entire disclosure of which is incorporated herein by reference, discloses an automatic bill payment enrollment system for recurring donations, which allows donors to automatically charge charitable donations on a recurring basis to a financial account. In one embodiment, the invention uses a donation portal having various webpages to allow a donor to donate to all U.S. 501(cX3) organizations. In an alternative embodiment, a donor may donate to any other desired organizations. The system may also incorporate a filter for restricting monies being sent to terrorist organizations. The invention also includes a loyalty point system, wherein loyalty points may be donated to a charity. In another exemplary embodiment, the invention also facilitates employee gift matching.

U.S. Patent Publication No. 2006/0206416 (David G. Farias), the entire disclosure of which is incorporated herein by reference, discloses a system and method for providing financial collaboration networks generally includes a data processing system adapted to permit a plurality of group collaborators to perform financial transactions with a plurality of users or network participants. Representative embodiments of the present invention generally provide web-based financial collaboration systems that may be adapted to permit a plurality of borrowers, for example, to negotiate more favorable terms with a lender for subsequent loans made to the borrower members of the collaborative group.

U.S. Patent Publication No. 2007/0179882 (Richard Intrator), the entire disclosure of which is incorporated herein by reference, discloses a method of increasing cash flow for a not-for-profit entity (201) includes: (a) pledging a donation amount as collateral for a loan amount while the donation amount remains unrealized by the not-for-profit entity; (b) investing the loan amount at an investment rate greater than a lending rate for the loan amount; and (c) pledging the invested loan amount as additional collateral for the loan amount.

U.S. Patent Publication No. 2008/0319898 (Thomas C. Crowl), the entire disclosure of which is incorporated herein by reference, discloses a donation system that would encourage registered individuals to make small contributions to a charity or political campaign (or cause of their choice) as well as facilitate the process of doing so. The system provides a central location for all donation activity and works as a “contribution bundler” to empower those otherwise disempowered in the political marketplace. The system also acts as a “Civic Marketplace” that gives citizens a central location to turn to for civic information. The system provides safety features for registered users.

U.S. Patent Publication No. 2010/0010927 (Garrett D. Melby), the entire disclosure of which is incorporated herein by reference, discloses a method of structuring ownership of an invention including the steps of receiving an investment commitment and a capital contribution from at least one investor, investing the capital contribution in a portfolio company, assigning a set of securities to the at least one investor based upon the capital contribution, the set of securities comprising a plurality of strips, and providing one or more of the plurality of strips to the at least one investor, wherein each of the plurality of strips is defined as a portion of the capital contribution and wherein at least one of the strips is dedicated for donation by the investor to at least one charity.

U.S. Patent Publication No. 2010/0262523 (Daniel Hugh Quigley), the entire disclosure of which is incorporated herein by reference, discloses methods and systems are provided for managing and soliciting donations made during checkout of a plurality of online purchases at a plurality of online retailers by a plurality of online shoppers. In one embodiment, the method and system include a receiving, over a communications network, data regarding a plurality of amounts for donation and a plurality of selected organizations made during checkout of the plurality of online purchases at the plurality of online retailers by the plurality of online shoppers, and collecting a plurality of payments for the plurality of amounts for donation and distributing the plurality of payments among the plurality of organizations based on the data. The method and system may include the online shoppers being asked at the time of checkout if they would like to round-up their total purchase price to the nearest dollar and select a charity/nonprofit organization to donate the spare change.

U.S. Patent Publication No. 2012/0078762 (David Valin, et al.), the entire disclosure of which is incorporated herein by reference, discloses a method for embedding a socially conscious donation, contribution, payment into a transaction at the point of sale or purchase using any payment platform that accepts, debit, credit, cash, financing, donations, contributions, financial service transactions, etc. and facilitates, separates, and keeps track of the process and the transaction, including the giveback. The system and method also handles contributions to any beneficiary which could be the person making the purchase or sale or barter. The system and method utilizes a human key to make and take requests, record payments, take and certify payments between a user or plurality of users, a merchant/business, and a charity of designated beneficiary. Whereby a set amount by the parties, user, purchaser, seller, and beneficiary can be used for a donation, contribution, or payment to a beneficiary determined at the point of sale, purchase, or barter.

Islamic Microfinance: A Missing Component in Islamic Banking, a paper published in January 2007, in the Kyoto Bulletin of Islamic Area Studies, by Abdul Rahim Abdul Rahman, the entire disclosure of which paper is incorporated herein by reference, in summary examines the potential of Islamic financing schemes for microfinance. This paper looks at several aspects of Islamic banking and microfinance, including that Islamic microfinance should involve not only credit through debt finance, but the provision of equity financing via mudarabah and musharakah, savings schemes via wadiah and mudarabah deposits, money transfers such as through zakat and sadaqah, and insurance via takaful concept. This paper in part states that the main objectives of microfinance are in line with the Islamic economic principles of justice. The author further states that, Islam prohibits conventional, interest-based microfinance schemes, and that various Islamic financing schemes based on the concepts of mudarabah, musharakah, murabahah, ijarah, etc., can contribute towards poor peoples financial development, in an ethical way. Since Islamic banking has not addressed the financing needs of poor people and microentrepreneurs, Islamic microfinance is argued as a missing component in Islamic banking. The author further states that many Islamic insurance companies use the wakalah model, and that Islamic banks can offer Islamic microfinance instruments using this model. The paper also highlights the need for further studies to examine the wakalah model and other possible structures and governance models, so that Islamic banks can effectively offer Islamic microfinance instruments, while mitigating its inherent risks. However, using a wakalah model for microfinance where zakat funds and donor funds are used as seed money to finance a microfinance institution, which will channel such donations to the borrowers for financing activities, still does not address the issues of loan defaults, and/or how the moneys in default would be recovered.

Leveraging Philanthropy Monetary Waqf for Micro Finance, by Dr. Muhammad Anas Zarka, the entire disclosure of which paper is incorporated herein by reference, proposes a Monetary Waqf (MW) of a variable size, whose major assets are monetary, to provide micro finance to the productive poor. MW depends, as usual in any waqf, on initial permanent donations whose expected income covers the administrative and maintenance needs of MW. A novel feature in the proposed waqf is the mobilization of temporary funds extended to MW as interest-free loans, on call or for a fixed term. MW guarantees repayment to providers of funds, and uses the funds to provide micro-finance to the productive poor in various Shariah Compliant modes, at terms that sustain the waqf but are most favorable to recipients. To strengthen its guarantee, MW must have two tiers of philanthropic guarantors: Guarantors of liquidity, and Guarantors of Losses. Guarantors of Losses help insulate fund providers from risk of default by microfinance recipients. This helps to attract to MW temporary funds many times larger than the guarantee commitments. Payments to make up the losses can be counted by these Guarantors towards their annual zakat obligations.

Introduction to Islamic Microfinance, by Mohammed Obaidullah, the entire disclosure of which paper is incorporated herein by reference, proposes a model, which follows the following eleven steps: (1) Islamic Microfinance institution or program creates a Zakat Fund with contribution from zakat payers, (2) Program facilitates Waqf of physical assets as well as monetary assets. The physical assets are used to facilitate education and skills training. The monetary assets may be in the form of a cash waqf, or simply as ordinary sadaqa, (3) Program carefully identifies the poorest of the poor and the destitute who are economically inactive and directs a part of Zakah Fund towards meeting their basic necessities as grant, seeks to provide a safety net, (4) Program provides skills training to economically inactive, utilizing community-held physical assets under waqf, (5) Beneficiaries graduate with improved skills and managerial acumen, (6) Beneficiaries are formed into groups with mutual guarantee under the concept of kafala, (7) Financing is provided on the basis of qard hasan to the group; also to individuals backed by guarantee under the concept of kafala, (8) Group members pay back and in turn, are provided higher levels of financing. (9) Additional guarantee against default by the group is provided by the Zakah Fund and actual defaulting accounts are paid off with zakah Funds, which is mentioned as a distinct feature of this model, (10) Group members are encouraged to save under appropriate microsavings schemes, (11) Groups members are encouraged to form a Takaful Fund to provide micro-insurance against unforeseen risks and uncertainties resulting in loss of livelihood, sickness and so on.

Zakah Management for Poverty Alleviation, by Dr. Mohammed Obaidullah, a 2012 publication, the entire disclosure of which publication is incorporated herein by reference, also proposes the above-mentioned eleven step composite model with an addition to use of the model in case of for-profit Islamic financial institutions, which will encourage them to finance microenterprises.

Islamic Social Finance Report 2014, a report prepared by IRTI (Islamic Research and Training Institute) with strategic partnership with Thomson Reuters, contemplates that there may be a case in favor of using zakah for covering genuine credit defaults by the poor, since such borrowers qualify as eligible beneficiaries in the eyes of Shariah. There is, however, need for adequate caution while designing an institutional mechanism for such a purpose. It is not easy to differentiate between genuine and willful defaulters for any microfinance institution operating with inadequate and imperfect information. The simultaneous functioning of a micro-credit initiative and a zakah-based initiative to cover credit defaults by poor borrowers under the same organizational umbrella may also involve serious conflict of culture and moral hazard issues.

This invention improves on the deficiencies of the prior art and provides an inventive apparatus, system, and method for securing loans for a borrower via the Biniog Sathi process.

### PURPOSES AND SUMMARY OF THE INVENTION

The invention is a Biniog Sathi apparatus, system, and a method thereof.

Therefore, one purpose of this invention is to find a sustainable solution to the problems of debt default in the financial services industry with the help of Zakat or charity funds.

Another purpose of this invention is to strengthen the existing Islamic banking model that is being practiced all over the world.

Yet another purpose of this invention is to develop a banking model that will be acceptable to all irrespective of race, color, religion, social class, etc.

Therefore, in one aspect this invention comprises a Biniog Sathi method, comprising the steps of:

(a) providing at least one means to accept at least one financial deposit from at least one depositor into a Biniog Sathi supported financial institution, and processing said at least one financial deposit via at least one electronic device over at least one communication network at said Biniog Sathi supported financial institution;
(b) said Biniog Sathi supported financial institution partnering with at least one independent zakat entity, and forming a contractual relationship between said at least one independent zakat entity and said Biniog Sathi supported financial institution;
(c) said Biniog Sathi supported financial institution providing at least one financial loan to at least one borrower from said at least one financial deposit;
(d) wherein said at least one independent zakat entity provides said borrower at least one security to secure said financial loan from said Biniog Sathi supported financial institution; and
(e) wherein said financial institution and said at least one independent zakat entity enters into an agreement for the benefit of said at least one borrower to guarantee said at least one financial loan for said at least one borrower.

In another aspect this invention comprises a Biniog Sathi system, comprising:

(a) a Biniog Sathi supported financial institution having at least one means to electronically accept and record financial deposits on an electronic device over at least one communication network, and at least one means to provide at least one financial loan;
(b) at least one depositor, said at least one depositor providing at least one financial deposit into said financial institution via at least one electronic means;
(c) at least one borrower, said borrower receiving at least one financial loan from said at least one financial deposit from said Biniog Sathi supported financial institution; and
(d) at least one independent zakat entity partnering with said financial institution for the benefit of said borrower and said Biniog Sathi supported financial institution, wherein said at least one independent zakat entity has a contractual relationship with said Biniog Sathi supported financial institution, and wherein said borrower uses said at least one independent zakat entity to provide at least one security to said Biniog Sathi supported financial institution to secure said financial loan for said at least one borrower.

In yet another aspect this invention comprises a non-transitory computer-readable storage medium with an executable program application stored thereon, the program application configured for coordinating to perform transactions associated with a Biniog Sathi supported financial institution, the program application configured to be accessible over a communications network, wherein the program application instructs a computer processor to perform the following steps of:

(a) receiving instructions to accept at least one financial deposit from at least one depositor into said Biniog Sathi supported financial institution, and entering said instructions for said at least one financial deposit into at least one electronic device via at least one communication network at said Biniog Sathi supported financial institution;
(b) receiving a set of instructions from at least one independent zakat entity;
(c) verifying that a contractual relationship exists between said at least one independent zakat entity and said Biniog Sathi supported financial institution;
(d) processing at least one financial loan for at least one borrower upon instructions from said Biniog Sathi supported financial institution from said at least one financial deposit; and
(e) confirming that said at least one independent zakat entity has sufficient security funds to secure said financial loan from said Biniog Sathi supported financial institution for said at least one borrower, and wherein said financial institution and said at least one independent zakat entity entering into an agreement for the benefit of said at least one borrower to guarantee said at least one financial loan for said at least one borrower.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1, illustrates a typical transaction of an existing banking or a financial institution, using a first embodiment of this invention.

FIG. 2, illustrates a second embodiment of this invention comprising a transaction utilizing Biniog Sathi.

FIG. 3, illustrates a third embodiment of this invention comprising an inventive transaction between a Zakat or charity fund, and donors and receivers.

FIG. 4, illustrates a fourth embodiment of this invention comprising an inventive transaction between a Zakat or charity fund, and donors and receivers.

### DETAILED DESCRIPTION

“Biniog Sathi” is a Bangla word from the Bengali language, where “Biniog” means “investment”, and “Sathi” means “friend”. Therefore, “Biniog Sathi” has been coined to mean “Friend in Investment”. A true friend can never let the life of his/her friend go into ruin or distress if he/she is in financial stress, and goes into default. Biniog Sathi supporters feel that a true financing institution should stand beside its borrowers in both good times and bad times. Thus, this is the essence of Biniog Sathi inventive model or concept.

Under the inventive concept of Biniog Sathi, the concept of Zakat or charity is integrated with the existing Islamic Banking model. In this new model, each participating bank or financial institutions will be renamed as “Biniog Sathi” or “Friend in Investment” or at least provide some indication that it is participating in the Biniog Sathi concept. Like any other bank or financial institution, each Biniog Sathi will collect deposits from the depositors and will channel those funds to the potential borrowers under Sharia compatible or similar financing modes. Depositors will receive their due return from Biniog Sathi, while Biniog Sathi will generate its income through financing the borrowers.

Besides normal lending and deposit operations like any other bank or financial institution, every Biniog Sathi will have a contractual relationship with an independent Zakat or charity fund. One of the objectives of the Zakat fund affiliated with Biniog Sathi will be to provide financial assistance to a debtor or if and when he or she fails to make repayments on the loan previously extended by the Biniog Sathi or the Biniog Sathi participating institution.

As one can appreciate that the Biniog Sathi inventive concept is generally related to the financial services industry. It particularly deals with the problem of debt default that persists in the financial services industry all over the world. Any bank or financial institution, no matter whether it is a conventional bank, a credit union, an Islamic bank, a Sharia compliant institution, or a micro-finance institution, it is exposed to the possibility of debt default by its borrowers. The Biniog Sathi inventive model offers a solution to the problem of debt default, and helps the existing banks and financial institutions to solve or eliminate this problem of debt default.

According to the Biniog Sathi inventive concept, every participating bank or financial institution will have a contractual relationship with an independent Zakat or charity fund. If any borrower defaults or fails to repay the loan of the bank or the financial institution, he/she will be allowed to have access to the Zakat or charity fund, and will be allowed to obtain the required financial assistance from the Zakat or charity fund, which will be equal to the amount due to the bank or the financial institution. Once the appropriate amount has been secured or obtained by the borrower, the borrower will then go back to the bank or the financial institution and either repay the due amount or catch-up with the previously established loan repayment schedule.

In order to reduce moral hazard or the abuse of zakat or charity by the banks, financial institutions, the borrower, or the zakat or charity fund, there will be an independent check through a process that will have to be followed by the banks, financial institutions, as they are the ones issuing the loan. Whether the process is followed as per an agreed mechanism, an independent compliance audit of the bank or the financial institution will be conducted, periodically, but, preferably at least once a year. This is important because if this issue is not addressed and is not transparent then abuse of zakat or charity could occur, and which would create its own sets of problems.

It is also contemplated that in order to have external checks so as to reduce moral hazard problems, a Central Bank, or Bank Governing body, or the government could implement Personal Identification System for all citizens to check their respective wealth and financial ability. Additionally, abuse of zakat or charity funds under the Biniog Sathi process could also be regarded as a criminal or a punishable offence by the government.

According to the Islamic Shariah principles, every Muslim citizen is obligated to contribute a certain percentage of his/her wealth for the benefit of certain class of people or for certain noble objectives every year. The classes of people who are eligible to receive Zakat or charity funds or donations or contributions are poor and needy, the Zakat collectors, the new reverts or converts to Islam, Non-Muslims who are sympathetic to Islam, the slaves who need to be freed, people in bondage who need to be freed, any person in debt, any traveler, children on the street, or similar other people. The wealth can also be spent for actions aimed for the cause of God or Allah. This obligatory tax or donation is referred to as Zakat. The literal meaning of the term ‘Zakat’ is to grow in goodness or ‘increase’ or ‘making pure’. So the act of giving Zakat means purifying one's wealth to gain God's blessings to make it grow in goodness. Since Zakat is a form of charity or donation, the words ‘Zakat’, ‘charity’, and “donation” may be used interchangeably.

Under the Biniog Sathi inventive concept the borrower will be able to repay the loan on time and without any escalation of any financial charges, and the bank or the financial institution will be able to obtain the outstanding amount on time, and will have sustainable business without any default of any of its outstanding loans.

According to Islamic Shariah principles, it is acceptable to use Zakat funds to provide assistance to the loan defaulters. These Zakat funds can also be utilized to provide assistance to the Zakat collectors. These two provisions of the use of Zakat will be used in the Biniog Sathi inventive model or concept. The Zakat or charity find will be managed by a team, which will be completely separate from the management of the bank or financial institution under Biniog Sathi concept, and the Zakat collectors will draw their salaries and expenses from the Zakat fund that they will manage. They will periodically collect Zakat or charity from the people, and after meeting the requirements of the loan defaulters, the Zakat balance will be utilized for providing assistance to other groups of people or causes that Islamic Sharia permits.

FIG. 1, illustrates a typical transaction of an existing banking or a financial institution 23, using a first embodiment of this invention, and having an inventive Biniog Sathi entity 49, associated therewith. As shown in FIG. 1, a bank or financial institution 10, obtains funds or deposits 12, from depositors 14, and then uses these funds 12, for lending to a borrower 24. The depositors 14, provide the funds or deposits 12, to the bank or financial institution 10, with an understanding of obtaining a ROI (Return on Investment) 16. The ROI 16, could comprise of a fixed interest rate 16, a variable interest rate 16, a profit sharing scheme 16, or any combination which increases the value of the deposits 12, and which are regularly or periodically provided to the depositors 14, while the funds or deposits 12, are being held by the bank or financial institution 10. Against such lending of the funds or deposits 12, to the borrower 24, the bank or financial institution 10, usually obtains collateral or securities 21, from the borrower 24, such securities 21, might include corporate guarantees 21, personal guarantees 21, pledge/mortgage on certain assets 21, to name a few. The borrower 24, upon receipt of the funds or loan 22, also agrees to not only return the original loan amount 22, but also to provide a mark-up 27. The mark-up 27, could comprise of a fixed interest rate 27, a variable interest rate 27, a profit sharing scheme 27, or any combination which increases the value of the loan amount 22. The mark-up 27, could be provided on a regular or a periodic basis to the financial institution 10. The mark-up 27, could also be a component or a part of a pre-established loan repayment schedule 26, which schedule is established when the borrower 24, obtains the loan 22. From the mark-up 27, the bank or financial institution 10, generates a profit 25, and the ROI 16. If the borrower 24, repays the loan 22, along with the mark-up 27, on time, then the bank 10, is able to generate profit 25, and is able to provide return 16, to the depositors 14. However, if and when the borrower 24, defaults or is unable to pay the mark-up 27, along with the loan repayment 26, the bank 10, then exercises its rights on the securities 21, to obtain the mark-up 27, and the balance that may be left on the loan 22. Under such circumstances the borrower 24, could lose everything if he or she suffers a default or is unable to repay the loan 22, and the mark-up 27. Thus, in the existing banking model 23, there is no window for the borrower 24, to receive financial assistance, if they default. However, the inventive Biniog Sathi entity 49, associated with an existing bank or financial institution 23, could be used to assist as will be clear below.

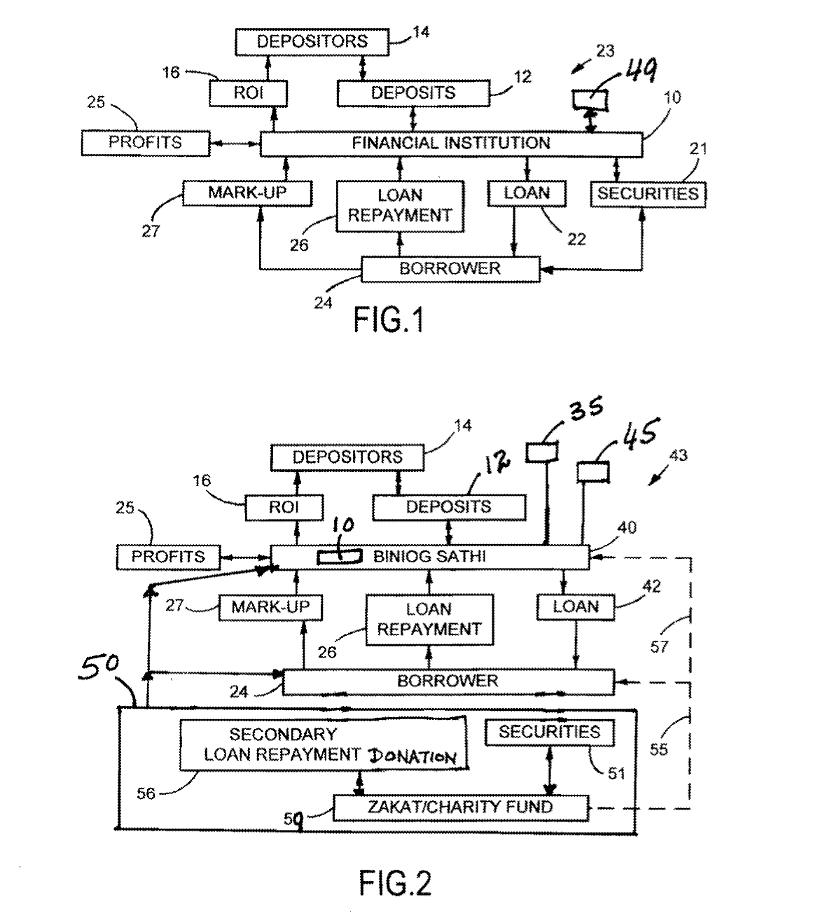

However, for a typical transaction of an existing banking or a financial institution 23, one could have a Biniog Sathi entity 49, similar to the Biniog Sathi 40, as discussed with reference to FIGS. 2, 3, and 4. The role of the Biniog Sathi entity 49, could be selected from a group comprising, a monitoring entity 49, an enforcing entity 49, an advisory entity 49, or a combination thereof, to name a few. It should be appreciated that the character of the Biniog Sathi entity 49, would be in line with or following the parameters as outlined for the Biniog Sathi inventive model or concept 43, as discussed with reference to FIGS. 2, 3, and 4.

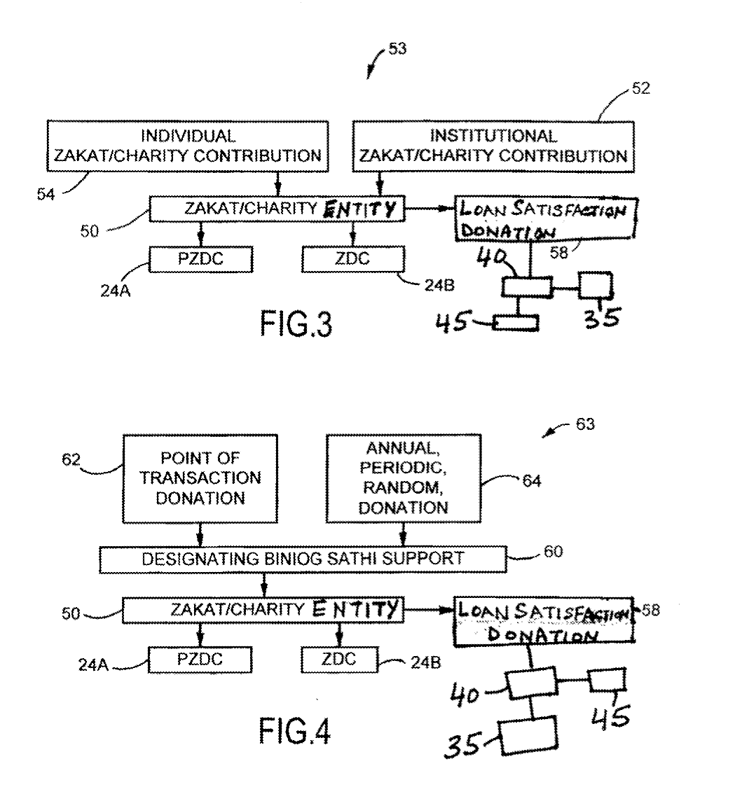

FIG. 2, illustrates a second embodiment of this invention comprising a transaction utilizing Biniog Sathi financial model or network 43. Under the Biniog Sathi inventive model or concept 43, every bank or financial institution 10, will be renamed as Biniog Sathi 40, or Biniog Sathi financial institution 40, or will have some indication that it is a partner of Biniog Sathi 40. The Biniog Sathi financial institution 40, will develop and have a relationship with at least one zakat or charity fund or institution or organization 50, which will provide financial assistance to the borrower 24, in case of default, as will be explained below. It should be appreciated that the charity fund or organization 50, has among its assets at least some zakat or charity funds 59. The charity fund or organization 50, could also have securities 51, that could be used as a collateral 51, for the benefit of the borrower 24, and/or it could have a separate fund 56, such as a secondary loan repayment donation fund 56, that could be used as a secondary loan repayment 56, for the benefit of the borrower 24, when the charity organization 50, is in partnership with the Biniog Sathi institution 40, and as a backer or supporter of the borrower 24. Thus, if and when a default occurs, the borrower 24, will have opportunity to discuss the default with both Biniog Sathi institution 40, and the zakat or charity fund institution 50, and then will have the option to access financial assistance from the zakat or charity fund 56, 59, and use this financial assistance 56, 59, to repay all or portion of the outstanding loan or the default portion to the bank or financial institution 10, 40. It should be understood that the zakat or charity fund or institution or organization 50, is an independent entity 50, and that its primary purpose or mission is to collect zakat or charity funds 56, 59, from individual donors 54, (FIG. 3), and/or organizational donors 52, (FIG. 3), and then use those funds 56, 59, for the betterment of the community or people. It should also be appreciated that the zakat or charity fund or institution or organization 50, is an independent entity 50, but for the purposes of Biniog Sathi 40, 43, 49, it is willing to partner with and/or lend its support to the Biniog Sathi financial institution 40, 49, in case of default by a borrower 24. As stated earlier that the charity organization 50, collects charity funds 59, along with loan repayment donations 56, and then disburses those funds 56, 59, for charity or community causes, and thus it is a Non-Profit entity 50, or a NGO (Non-Governmental Organization) 50. The charity entity 50, does not seek to profit from its funds 56, 59, but it uses those funds 56, 59, for the benefit that may be in its charter or as designated by an individual donor 54, or a corporate donor 52. It should be understood that the Biniog Sathi inventive model 43, utilizes several features from the existing banking model 23, as illustrated in FIG. 1, however, instead of the borrower 24, providing securities 21, as a collateral 21, the borrower 24, engages the Zakat or charity fund 50, which in one sense provides a collateral or securities 51, to the institution participating as Biniog Sathi 40, while obtaining the loan 42. During the origination of the loan 42, Biniog Sathi participating institution 40, the borrower 24, and the Zakat or charity fund 50, have an agreement via process 55, 57, as to the rights and obligations of each of the participating party 40, 24, 50. For some transactions the Biniog Sathi inventive model 43, could also include a secondary loan repayment concept 56, which would allow the borrower 24, to partially or fully access the secondary loan repayment schedule 56, to partially or fully repay the loan 42, along with any mark-up 27, that may be due, using the secondary loan repayment schedule 56. The criteria for establishing access to the secondary loan repayment schedule 56, could be universal or could be customized for each borrower 24, or could be based on any criteria, such as, need, change in circumstances, business or personal reasons, to name a few. It should be appreciated that a computer or a similar electronic device 35, using a communication network 45, is used to provide the support for the various steps used to accomplish the process and method of the instant invention. For example, the computer 35, using the network 45, could be used by a depositor 14, to deposit funds 12, into the Biniog Sathi institution 40, or to receive funds 16, from the Biniog Sathi institution 40. Similarly, a borrower 24, could use the computer 35, via the communication network 45, to obtain a loan 42, to pay the loan 26, to pay the markup 27, to communicate with Biniog Sathi 40, and/or charity entity 50, etc. The charity entity 50, would also use the computer 35, on the commination network 45, to provide the security or assurance 51, to process the zakat or charity funds 59, to make secondary loan repayments 56, to communicate with the borrower 24, and/or communicate with the Biniog Sathi institution 40, etc. Thus, each entity 14, 40, 24, 50, or any of the steps or processes in the Biniog Sathi financial model 43, will have full access or the benefit of the computer or electronic device(s) 35, along with the support or benefit from the supporting communication network 45. It should be understood that even though the borrower 24, is obtaining a financial loan 42, from a Biniog Sathi financial institution 40, it is also seeking help from the charity entity 50, to not only provide an initial collateral 51, or security 51, to support the loan 42, but also to replace the outstanding balance of the loan repayment 26, and/or any mark-up 27, in case of default of the borrower 24, using funds from the charity entity 50, such as, secondary loan repayment funds 56. It should also be understood that during the loan origination process Biniog Sathi financial institution 40, the borrower 24, and the charity entity 50, have a written agreement 55, 57, to clearly spell out the rights and responsibilities of each participant 40, 24, 50, and thus this way the Biniog Sathi financial institution 40, has a charity entity 50, that is acting as a guarantor 50, of the loan 42, and the borrower 24, has the peace of mind that in case of a potential default he or she has a “friend” or “sathi” to help with the default. Such a concept or institution has never existed before, and thus this is unique invention, which covers and protects all parties of the financial loan transaction, namely, the Biniog Sathi financial institution 40, has an institution 50, protecting its loan funds 42, along with the mark-up 27; the borrower 24, has a “friend” or “sathi” 50, who can come to the borrower's rescue in case of loan default; the charity entity 50, is utilizing funds 51, 56, 59, entrusted from the donors 52, 54, to help a person/borrower 24, especially in the time of his need. It should be appreciated that the Biniog Sathi financial institution 40, could be a stand-alone institution 40, or it could be a Biniog Sathi entity 49, as discussed with reference to FIG. 1. Furthermore, it could be a Biniog Sathi supported financial institution 40, or it could be a Biniog Sathi supported financial institution 40, having either a contractual relationship with a financial institution, such as, a financial institution 10, of FIG. 1, or optionally, a financial institution 10, could be within the structure of the Biniog Sathi financial institution 40. Regardless of the relationship between the financial institution 10, 40, it must be emphasized that the Biniog Sathi model must be adhered to, especially, as it relates to a borrower 24, a zakat or charity entity 50, loan origination terms and conditions, remedies available in the event of a default by the borrower 24, etc.

It should be further appreciated that the relationship that is created between a bank 10, 40, or a financial institution 10, 40, and an independent zakat, or a charity entity 50, having zakat or charity funds 51, 56, 59, in support of a borrower 24, to address loan default only and at the same time offering a mechanism to reduce moral hazard has never been done or suggested, prior to the Biniog Sathi process 43.

It should also be understood that the depositor 14, can be an individual 14, a for-profit entity 14, a not-for-profit entity 14, a financial institution 14, to name a few. Similarly, the borrower 24, can be an individual 24, a for-profit entity 24, a not-for-profit entity 24, a financial institution 24, to name a few, however, in case of the Biniog Sathi inventive concept the borrower 24, at the time of the loan or default must be an entity 24, that is eligible or entitled to be considered a zakat or charity fund deserving entity 24.

FIG. 3, illustrates a third embodiment of this invention 53 comprising an inventive transaction 53, between a zakat or charity fund 50, and donors 52, 54, and receivers 24A, 24B. Using the Biniog Sathi inventive model 43, in order to provide the zakat or charity entity 50, with sufficient funds, it is contemplated that individual contributors 54, and institutional contributors 52, would make their regular or periodic donations or contributions to the zakat or charity entity 50. The zakat or charity entity 50, in turn would help borrowers 24, at their time of need, as a loan satisfaction donation 58, to a financial institution 10, 40, as already discussed with reference to FIG. 2, and any surplus within the zakat or charity fund 50, would be donated via donations 58, according to either established Sharia Islamic law, or on a criteria according to the charter of the zakat or charity entity 50. It should be appreciated that the borrowers 24, could comprise of at least two different group of borrowers 24. The first group of borrowers 24, could be termed the Partially Zakat Dependent Client (PZDC) 24A, and the second group of borrowers could be classified as Zakat Dependent Client (ZDC) 24B. One could also establish other criteria to classify the borrowers 24, such as, on the basis of the assistance received from the Zakat entity 50, to classify the at least two groups, namely, the Partially Zakat Dependent Client (PZDC) 24A, and the Zakat Dependent Client (ZDC) 24B. This information could also be used for the amount, and/or terms and conditions for the future financing to these two groups of borrowers 24A, 24B, and it could also vary on the basis of their previous dependency on the funds 42, from the zakat or charity entity 50. For example, the less a borrower 24, 24A, 24B, is dependent upon the zakat or charity fund of the charity entity 50, the more rewarding the future financing or security 51, or secondary loan repayment 56, could be. It should also be understood that all steps and processes of the third invention 53, could use at least one computer 35, utilizing at least one communication network 45.

FIG. 4, illustrates a fourth embodiment of this invention 63, comprising an inventive transaction 63, between a Zakat or charity entity 50, and donors 62, 64, and receivers 24A, 24B. Using the Biniog Sathi inventive model 43, in order to provide the funds to the zakat or charity entity 50, with sufficient funds, it is contemplated that the zakat or charity entity 50, would accept point of transaction donations 62, and/or annual, periodic, random, donations 64, where the donor 62, 64, would designate Biniog Sathi institution 40, 60, as either the recipient 40, 60, or one of the recipient 40, 60, of the donation by the donor 62, 64 to the Zakat or charity entity 50. As stated earlier that the Zakat or charity entity 50, would in turn help borrowers 24, 24A, 24B, at their time of need, as a loan satisfaction donation 58, to a financial institution 10, 40, as already discussed with reference to FIGS. 2, and 3, and any surplus of funds within the Zakat or charity entity 50, would be donated via donations 58, according to either established Sharia Islamic law, or on a criteria according to the charter of the Zakat or charity entity 50. It should also be understood that all steps and processes of the fourth invention 63, could use at least one computer 35, utilizing at least one communication network 45.

As one can appreciate that the Biniog Sathi inventive model 43, provides an alternative banking model 43, that solves the problem of debt default, and offers a simple and practical solution to the problem of debt default within the existing banking systems or institutions.

It is preferred that the Zakat or charity fund 50, be a separate entity 50, and be completely independent of the management of Biniog Sathi 40. The Zakat or charity fund 50, will have its own employees to collect Zakat or charity from the people or donors 54, 62, 64, or institutions 52, and they will draw their salaries or wages from the Zakat or charity fund 50, and since it is permissible in the Islamic Sharia law for the Zakat collectors to accept payment or compensation from the Zakat collected. Therefore, the source of the capital of Biniog Sathi 40, and the Zakat fund 50, will be completely different from each other.

The Biniog Sathi inventive model 43, is more economically competitive compared to conventional, Islamic or microfinance banking models due to numerous factors, such as, for example, the Biniog Sathi inventive model 43, complies with all Sharia Islamic principles, and at the same time, resolves the problem of debt default. Thus, it strengthens the existing Islamic banking model by incorporating the concept of Zakat or charity fund 50. The borrower 24, under the Biniog Sathi inventive model 43, does not have to worry about being ruined by losing everything if he or she goes into default and at the same time the bank 10, 30, or financial institution 10, 30, does not need to force the borrower 24, to pay off the loan 22, which is a usual case for a contemporary financial institutions 10, under similar circumstances.

Biniog Sathi inventive model strengthens the present Islamic banking model because the model complies with the verse 280 of Sumra Baqara of the Holy Quran. The verse says, “If the debtor is in a hard time, then grant him time till it is easy for him to repay, but if you remit it by way of charity, that is better for you if you did but know”. Since there is a restriction in sharia or Islamic law to force borrowers in case of a delayed payment, present Islamic banks charge a penalty to the borrower in case the loan payment is delayed and donate this sum or amount to a charity. This is done due to the problems of moral hazard. If such penalty is not enforced, the borrowers will have incentives to delay the payments of loans for Islamic banks. Biniog Sathi inventive model resolves this problem by incorporating the Zakat Fund, and therefore, strengthens the Islamic banking model by fully complying with the sharia rules. This is an important feature of this invention as the issue of removing the late payment penalty was never addressed before.

It is contemplated that Biniog Sathi transactions would be free from any late payment penalty, which is contrary to the sharia principles, but does not make it un-Islamic. One of the reason for this suggestion is that Biniog Sathi transactions are primarily aimed at people with limited resources to start with, and thus reducing any burden would not only help them as a borrower, but would also be for the greater good of the community. For example, if any Biniog Sathi borrower misses a particular payment, then his/her unpaid installment would be added with the remaining installments, and/or distributed evenly through the remaining term of the financing period. At the end of the financing period or term, if there are still any unpaid amounts, then, for example, the bank or the financial institution could give the borrower a grace period, such as, for example, a 6 months grace period could be offered to the defaulting borrower, to pay the defaulting amount. However, for some other transactions the borrower who has been late in his payments, and whose late payments have been merged back into or added to the principal, could be given the option to approach the charity entity that had backed the loan for default loan assistance.

During the grace or extension of loan repayment period, or at any time the borrower is contemplating default on the loan, the bank, or the financial institution could investigate the case of the defaulting borrower in order to determine whether the default is genuine or not. If the claim of default is genuine, then the bank or the financial institution could, for example, provide the defaulting borrower with a certificate or some written instrument confirming that the default has some merits. The defaulting borrower could then submit that certificate or papers to the zakat or charity organization with which the bank or the financial institution has relationship or was a cosigner of the loan in the first place, in order for the zakat or charity organization to step-in and meet their obligation in making the bank or the financial institution whole again. Based on this understanding, the zakat or charity fund would then honor the certificate or the instrument to pay the unpaid balance to the borrower 24, and/or to the financial institution 10, 40, and then the borrower 24, would endorse the repayment portion, or the defaulted portion to the bank 10, 40, or the financial institution 10, 40, and then repay the outstanding loan balance that is due to the bank or the financial institution 10, 40. Thus, with this inventive Biniog Sathi process 23, 43, 53, 63, the bank 10, 40, will benefit from recovering its unpaid loans, the borrower 24, will be able to be free from the debt burden, and zakat or charity fund 50, will be able to utilize its balance as intended by the donor(s) 52, 54, 62, 64, etc.

It should be understood that with the Biniog Sathi process the zakat or charity fund organization will not provide any blanket guarantee against the financing extended by the bank, or the financial institution, to the borrower. Here, the zakat or charity funding organization will also have the right to say “No” to the borrower if there is a suspicion that there might not be a genuine default, or for example, it is discovered that the default was deliberate, or that the borrower has sufficient assets to satisfy the default portion of the loan, etc.

Furthermore, in order to discourage borrowers to declare willful default, the bank or the financial institution could impose extra mark-up or reduce the size of any future financing to those borrowers who have received zakat or charity assistance in the past to payoff all or a portion of their previous loan.

The borrower 24, does not have to offer any real asset(s) as collateral 21, against the financing 22. It is because as long as the Biniog Sathi financial institution 40, 60, has the support from the Zakat or charity entity 50, and it has the sufficient balance, the Biniog Sathi financial institution 40, 60, will not run any risk of bad debts.

Within the financial institution 10, 40, 60, the definition of credit risk will change due to the support from the Zakat or charity entity 50, and the Biniog Sathi entity 40, 60, will be able to offer loans 42, to the borrower 24, at a more competitive rate than the market.

In the conventional banking system 23, the government might have to intervene into the banking system 23, in case of mass default of the borrowers 24. However, under the Biniog Sathi banking system 43, such intervention is unlikely to happen due to the absence of default by the borrowers 24.

This is the first time the concept of Zakat or charity funds 51, 56, 59, is being incorporated in the banking system 10, 40, 60, that will provide financial assistance to the borrowers 24, for the case of addressing loan default only.

The incorporation of the Zakat or charity funds from the charity entity 50, with the existing banking system 23, strengthens the existing Islamic banking model by resolving the problems of debt default.

The classification of the borrowers 24, in terms of their dependence on the Zakat fund 51, 56, 59, is a new concept. As stated earlier under the Biniog Sathi inventive model 43, the borrower 24, can be classified as partially Zakat dependent client (PZDC) 24A, and the Zakat dependent client (ZDC) 24B, in terms of their dependency on the Zakat fund 51, 56, 59, in case of default.

At the end of the calendar year, or fiscal year, or a pre-established point of time the Zakat or charity fund 51, 56, 59, after meeting all the Zakat or financial requirements of the borrowers 24, 24A, 24B, who faced full or partial default of loans 42, the remaining balance of the Zakat or charity fund 59, would be spent on other charitable areas or donations 58, which are permitted under the Sharia Islamic principles, or on a criteria according to the charter of the Zakat or charity fund 51, 56, 59.

Under the Biniog Sathi inventive concept 43, there is less likelihood that Government would need to intervene in the banking system 10, 40, 60, in case of mass default of the borrowers 24. It is due to the available support of the Zakat or charity fund 51. 56, 59. This is a new concept in the existing banking system 23. Therefore, if all the existing banks/financial institutions 23, adopt Biniog Sathi inventive concept 43, the resultant financial system would be more stable.

Biniog Sathi Model 43, incorporates the concept of Zakat or charity fund 51, with the existing banking system 23, under which a borrower 24, will have access to financial assistance in case he or she defaults on bank loans 42. If the borrower 24, defaults on a loan 42, extended by a bank 40, 60, then he or she will obtain financial assistance from the Zakat or charity fund 59, and will partially or fully pay-off the loan 42. The amount of Zakat assistance will be equal to the amount due to the bank 40, 60, or amount needed by the borrower 24. Therefore, the bank 40, 60, will be able to obtain its unpaid amount, and the borrower 24, will be able to be free from any debt obligations 42. This will help banks 40, to reduce their credit risks, and as a result, banks 40, will tend to extend loans 42, without any security 21, as long as there is sufficient balance in the Zakat or charity fund 51, 56, 59. This will eventually help to eliminate the problem of debt default from the existing banking system 23.

As discussed earlier, if and when, the borrower 24, faces problem in repaying the loan amount 42, he/she might opt for receiving financial assistance from the Zakat window 51, of Biniog Sathi financial institution 40, 60. The assistance might be equal to the missed installment or less depending on the financial capacity of the borrower 24. After obtaining the financial assistance from the Zakat or charity fund 50, the borrower 24, will repay the outstanding amount of the loan 42, to Biniog Sathi financial institution 40, 60, and thus will be free from any debt obligations. Biniog Sathi financial institution 40, 60, will also be benefited from getting the loan 42, repaid from the borrower 24, without any additional expenses, such as, for example, using a debt collector, or a court proceeding, or writing-off the debt 42, to name a few.

The Biniog Sathi inventive model or concept 43, has been presented using Islamic principles, however, it should be understood that the Biniog Sathi inventive model or concept 43, can be used by any organization or institution as long as the essential features of the Biniog Sathi inventive model or concept 43, are present, such as, a depositor 14, a borrower 24, a Biniog Sathi supportive institution or organization 40, and a zakat or charitable organization 50, that is willing or has the capacity to provide security 51, to the lending institution 40, and then be able to assist both the borrower 24, and the financial institution 40, in a debt default situation.

The Biniog Sathi inventive model or concept 43, can be replicated by any financial institution, however, it should be understood that for replication, the financing modes and the activities of the replicating institution have to comply with the sharia principles. This is also a very important feature of this invention because if we do not have this regulation, all conventional banks will enter into an agreement with a charity fund, and will benefit from Biniog Sathi invention without following the Islamic finance methods. Since the invention of the Biniog Sathi inventive model or concept 43, is religion neutral, complying with such requirements will allow religious Muslims to have access to financing from a replicating financing institution no matter whether it is operated by Christians, Jews, Hindus, or any other religious or non-religious group or institution.

It is also contemplated that individuals or institutions or organizations managing the Zakat or charity fund 50, could designate that a portion or a certain amount of the Zakat or charity fund 50, collected be designated towards the support of the Biniog Sathi inventive model or concept 43. The amount designated in support of the Biniog Sathi inventive model or concept 43, could vary from about zero percent to about 100 percent or any amount or percentage in-between.

It should be appreciated that there are banks or financial institutions that do not collect deposits from depositors, for example, Islamic Development Bank, World Bank, Non-Bank Financial Institutions, to name a few. These banks or financial institutions do not collect deposits, but rather uses their capital for lending operations. These banks and financial institutions can also benefit from Biniog Sathi model.

The Biniog Sathi process can also be replicated by corporate entities where two or more corporations or institutions could join together to extend loans to their respective staffs or employees. And, if there is a default by the staff or the employee, then there could be zakat or charity assistance that could be provided by the corporate entities to those loan defaulting staff to remedy the default. However, for such a scenario there has to be a restriction that the corporate entities would not receive their own zakat or charity assistance because this is contrary to the Islamic sharia principles. To avoid such possibility, for example, Corporation A could provide zakat or charity assistance to the defaulted staff of Corporation B, while the Corporation B could do the same for the defaulting staff of Corporation A. In this way, the sharia compatibility of the entire structure will be maintained.

This invention could also utilize a non-transitory computer-readable storage medium with an executable program application stored thereon 35, the program application configured for coordinating to perform transactions associated with a financial institution 40, the program application configured to be accessible over a communications network 45, wherein the program application instructs a computer processor 35, to perform the following steps of, receiving instructions to accept at least one financial deposit 12, from at least one depositor 14, into the financial institution 40, and entering the instructions for the at least one financial deposit 12, into at least one electronic device 35, via at least one communication network 45, at the Biniog Sathi financial institution 40. The program application would also be capable of receiving a set of instructions from at least one independent zakat or charity entity 50, and then being able to verify using links 55, 57, that a relationship exists between the at least one independent zakat or charity entity 50, and the Biniog Sathi financial institution 40. The program application would then be able to process at least one financial loan 42, for at least one borrower 24, upon instructions from the Biniog Sathi financial institution 40, from the at least one financial deposit 12, and then be able to confirm via the communication network 45, that the at least one independent zakat or charity entity 50, has sufficient security funds 51, 56, 59, to secure the financial loan 42, from the Biniog Sathi financial institution 40, for the at least one borrower 24. As stated earlier that during the Biniog Sathi process 43, the Biniog Sathi financial institution 40, the at least one independent zakat or charity entity 50, and the at least one borrower 24, all have vested interest in the underlying transaction, and are all party to the financial transaction, which is basically a loan 42, that is being backed or supported by the zakat or charity entity 50, using securities 51, and/or zakat/charity funds 59, and/or secondary loan repayment funds 56, to repay the loan 42, or a portion of the loan 42, that is in default to the Biniog Sathi financial institution 40.

It should be understood that various electronic components associated with the Biniog Sathi inventive model or concept 43, have not been shown with reference to FIGS. 1-4, however, those electronic components are well known in the art, such as, a computer, an electronic tablet, a smart phone, a personal digital assistant (PDA), a wireless network, a wired network, the Internet, to name a few.

The electronic device 35, could be selected from a group comprising, a computer, an electronic tablet, a smart phone, a personal digital assistant (PDA), and combinations thereof, to name a few. It should be understood that the electronic device 35, can be used to conduct all aspects of the Biniog Sathi transactions 43, such as, for example, accepting and recording of financial deposits 12, 16, 25, 27, processing of loans 42, notifying interested parties 40, 24, 50, of loan default conditions, accepting full or partial payment 56, 59, from a zakat or charity entity 50, to name a few.

The communication network 45, could be selected from a group comprising a wireless network, a wired network, the Internet, and combinations thereof, to name a few.

It should further be understood that the Biniog Sathi invention is very different than all the concepts presented earlier, for example, the entire process of using zakat for debt default was not presented as presented in the Biniog Sathi invention. Furthermore, the issue of moral hazard has not been addressed, and no description has been provided for ways to reduce the abuse of Zakat. If moral hazard issue is not addressed, then the entire structure will collapse, and whereas Biniog Sathi invention has addressed this issue. Additionally, with Biniog Sathi 40, 43, 49, both Zakat and Charity funds 50, are included and there is contractual relationship created between an independent Zakat and Charity Fund 50, and a financial institution 10, 40. The independent feature of this fund is very important because according to sharia guideline, one cannot take back his own zakat or charity, and therefore, if the fund is not independent of the financial institution, the entire structure will not be sharia compatible or compliant. Other models have this deficiency, such as, for example, the zakat donor (Muzakki) is also benefiting from his own zakat, which is contrary to sharia laws. Also, developing a sustainable Islamic banking model without the use of Late Payment Penalty has not been tried anywhere else. Furthermore, with Biniog Sathi the inventor has isolated the use of zakat and charity for addressing debt default only, and thus he did not include other uses of zakat and charity fund, and that is why the structure of Biniog Sathi invention is the simplest. In addition to this, the entire Biniog Sathi model has been proposed from the perspectives of the financial institutions in order to resolve their debt default problem, which is a new approach. Poverty alleviation and economic empowerment of people are built-in features of Biniog Sathi model because the model can be applied for all types of financial institutions, i.e., conventional banks, Islamic banks, and microfinance institutions, to name a few.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A Biniog Sathi method, comprising the steps of:
(a) providing at least one means to accept at least one financial deposit from at least one depositor into a Biniog Sathi supported financial institution, and processing said at least one financial deposit via at least one electronic device over at least one communication network at said Biniog Sathi supported financial institution:
(b) said Biniog Sathi supported financial institution partnering with at least one independent zakat entity, and forming a contractual relationship between said at least one independent zakat entity and said Biniog Sathi supported financial institution;
(c) said Biniog Sathi supported financial institution providing at least one financial loan to at least one borrower from said at least one financial deposit;
(d) wherein said at least one independent zakat entity provides said borrower at least one security to secure said financial loan from said Biniog Sathi supported financial institution; and
(e) wherein said financial institution and said at least one independent zakat entity enters into an agreement for the benefit of said at least one borrower to guarantee said at least one financial loan for said at least one borrower.

2. The Biniog Sathi method of claim 1, wherein said Biniog Sathi supported financial institution provides a return on investment to said depositor against said at least one financial deposit.

3. The Biniog Sathi method of claim 1, wherein said Biniog Sathi supported financial institution provides a return on investment to said depositor against said at least one financial deposit, and wherein said return on investment is selected from a group consisting of a fixed interest rate, a variable interest rate, a profit sharing scheme, and any combination thereof.

4. The Biniog Sathi method of claim 1, wherein said Biniog Sathi supported financial institution charges a markup for said financial loan by said at least one borrower.

5. The Biniog Sathi method of claim 1, wherein said at least one security from said at least one independent zakat entity comprises of at least one charitable asset of said at least one independent zakat entity.

6. The Biniog Sathi method of claim 1, wherein at least one donor entity provides at least one charitable contribution to said at least one independent zakat entity.

7. The Biniog Sathi method of claim 1, wherein at least one donor entity provides at least one charitable contribution to said at least one independent zakat entity, and wherein said donor entity designates a percentage of said at least one charitable contribution towards Biniog Sathi supported financial institution.

8. The Biniog Sathi method of claim 1, wherein at least one donor entity provides at least one charitable contribution to said at least one independent zakat entity, and wherein said donor entity designates a percentage of said at least one charitable contribution towards Biniog Sathi supported financial institution, and wherein said percentage is between zero percent and one hundred percent of said at least one charitable contribution.

9. The Biniog Sathi method of claim 1, wherein at least one donor entity provides at least one charitable contribution to said at least one independent zakat entity, and wherein said charitable contribution is made at a point selected from a group consisting of point of transaction donation, an annual donation, a periodic donation, a random donation, and any combination thereof.

10. The Biniog Sathi method of claim 1, wherein at least one donor entity provides at least one charitable contribution to said at least one independent zakat entity, and wherein said donor entity is selected from a group consisting of an individual donor, a corporate donor, and an institutional donor.

11. The Biniog Sathi method of claim 1, wherein upon default by said borrower of said financial loan said at least one independent zakat entity provides assistance to the defaulted borrower against the balance of any amount due on said financial loan.

12. The Biniog Sathi method of claim 1, wherein upon default by said borrower of said financial loan said at least one independent zakat entity provides assistance to the defaulted borrower against the balance of any amount due on said financial loan, and wherein said borrower is then classified from a group selected from a partially Zakat dependent client (PZDC), and a Zakat dependent client (ZDC).

13. The Biniog Sathi method of claim 1, wherein said Biniog Sathi supported financial institution has at least one department to process default applications.

14. The Biniog Sathi method of claim 1, wherein said Biniog Sathi supported financial institution generates financial profits from said borrower of said financial loan.

15. The Biniog Sathi method of claim 1, wherein said Biniog Sathi supported financial institution generates financial profits from said borrower of said financial loan, and wherein a portion of said financial profit is provided to said at least one depositor as a return on investment.

16. The Biniog Sathi method of claim 1, wherein said Biniog Sathi supported financial institution is selected from a group consisting of a conventional bank, a credit union, an Islamic bank, a Sharia compliant institution, and a micro-finance institution.

17. A Biniog Sathi system, comprising:
(a) a Biniog Sathi supported financial institution having at least one means to electronically accept and record financial deposits on an electronic device over at least one communication network, and at least one means to provide at least one financial loan;
(b) at least one depositor, said at least one depositor providing at least one financial deposit into said financial institution via at least one electronic means;
(c) at least one borrower, said borrower receiving at least one financial loan from said at least one financial deposit from said Biniog Sathi supported financial institution; and
(d) at least one independent zakat entity partnering with said financial institution for the benefit of said borrower and said Biniog Sathi supported financial institution, wherein said at least one independent zakat entity has a contractual relationship with said Biniog Sathi supported financial institution, and wherein said borrower uses said at least one independent zakat entity to provide at least one security to said Biniog Sathi supported financial institution to secure said financial loan for said at least one borrower.

18. A non-transitory computer-readable storage medium with an executable program application stored thereon, the program application configured for coordinating to perform transactions associated with a Biniog Sathi supported financial institution, the program application configured to be accessible over a communications network, wherein the program application instructs a computer processor to perform the following steps of:
(a) receiving instructions to accept at least one financial deposit from at least one depositor into said Biniog Sathi supported financial institution, and entering said instructions for said at least one financial deposit into at least one electronic device via at least one communication network at said Biniog Sathi supported financial institution;
(b) receiving a set of instructions from at least one independent zakat entity;
(c) verifying that a contractual relationship exists between said at least one independent zakat entity and said Biniog Sathi supported financial institution;
(d) processing at least one financial loan for at least one borrower upon instructions from said Biniog Sathi supported financial institution from said at least one financial deposit; and
(e) confirming that said at least one independent zakat entity has sufficient security funds to secure said financial loan from said Biniog Sathi supported financial institution for said at least one borrower, and wherein said financial institution and said at least one independent zakat entity entering into an agreement for the benefit of said at least one borrower to guarantee said at least one financial loan for said at least one borrower.

19. The non-transitory computer-readable storage medium of claim 19, wherein funds into said at least one independent zakat entity are electronically deposited via charitable contribution into said at least one fund of said at least one independent zakat entity, and wherein said charitable contribution is made at a point selected from a group consisting of point of transaction donation, an annual donation, a periodic donation, a random donation, and any combination thereof.

20. The non-transitory computer-readable storage medium of claim 19, wherein said Biniog Sathi supported financial institution is selected from a group consisting of a conventional bank, a credit union, an Islamic bank, a Sharia compliant institution, and a micro-finance institution.
